(19) United States
(12) Patent Application Publication
(10) Pub. No.: US 2014/0241818 A1
(43) Pub. Date: Aug. 28, 2014

(54) METHOD AND DEVICE FOR DISPENSING A FLUIDIZABLE MATERIAL AND INSTALLATION INCLUDING SUCH A DEVICE

(71) Applicant: RIO TINTO ALCAN INTERNATIONAL LIMITED, Montréal (CA)

(72) Inventors: Patrick Tamagno, Roquevaire (FR); Christian Cloue, Gardanne (FR)

(73) Assignee: RIO TINTO ALCAN INTERNATIONAL LIMITED, Montreal, QC (CA)

(21) Appl. No.: 14/349,768

(22) PCT Filed: Oct. 1, 2012
(86) PCT No.: PCT/IB2012/002600

§ 371 Date: Apr. 4, 2014

(30) Foreign Application Priority Data
Oct. 4, 2011 (FR) 1103012

(51) Int. Cl. B65G 53/16

(52) U.S. Cl. CPC B65G 53/16
USPC 406/108

(57) ABSTRACT

The invention relates to a method for distributing powder by means of a main conveyor (3) between a feed zone (1) and a plurality of receiver units (R1, R2, R3, R4, R5) arranged along said main conveyor, said method including:
(a) filling the conveyor as far as a downstream receiver unit,
(b) isolating the feed zone, and
(c) conveying the powder from at least one portion of the main conveyor to at least one receiver unit.

The invention also concerns a device for implementing the distribution method and an installation for the production of aluminum by igneous electrolysis including said means for feeding a series of cell feed hoppers in said installation.

### CROSS-REFERENCE TO RELATED APPLICATIONS

The present application is a U.S. National Phase filing of International Application No. PCT/IB2012/002600, filed on Oct. 1, 2012, designating the United States of America, and claiming priority to French Patent Application No. 11/03012, filed Oct. 4, 2011, and this application claims priority to and the benefit of the above-identified applications, which are incorporated by reference herein in their entireties.

### TECHNICAL FIELD

The invention relates to a method and a device for distributing materials having the characteristics of fluidizable powders, via a main conveyor between a feed zone, for example, a storage area, and a plurality of receiver units placed along said main conveyor.

The invention relates in particular to a method and a device for transporting and supplying “reserve-capacities” with product in powder form, for example alumina, to supply, from a storage zone of said powder material, a conditioning unit such as a bag-filling machine, or a production unit such as an extrusion machine or a series of igneous electrolysis cell feed hoppers for the production of aluminum.

### BACKGROUND

The powder transport device described in European patent EP 0 179 055 allows continuous supply of solid powders in a hyperdense phase. It is in particular used to supply alumina, systematically and continuously, to distribution and storage hoppers located in the superstructure of electrolytic cells. This device includes, between the storage zone and the zone to be supplied, at least one horizontal conveyor, made up of a lower channel designed for the circulation of a gas, and a higher channel designed for the circulation of powder and gas, the two channels being separated by a porous wall, through which said gas can pass. The lower channel is supplied with gas by at least one feed pipe. The powder completely fills the higher channel of the conveyor and this conveyor is provided with at least one balancing column partially filled with powder, the filling height of the solidgas suspension balancing the gas pressure.

To enable a continuous supply of solid powders, this device requires a continuous supply of fluidizing gas over the entire length of the horizontal conveyor.

There is a need to provide conveying for powder from a feed zone and a set of receiver units distributed along a main conveyor while minimizing the amount of energy consumed. In the case of a pneumatic conveyor or fluidized conveyor, this energy can be expressed in terms of the amount of gas used to transport the powder. One solution for reducing the energy consumption may be to perform powder conveying with a discontinuous gas supply.

The international patent application WO 02/074670 describes a method for discontinuous distribution of a fluidizable material between a tank and the receiver units, with a fluidized conveyor between at least two hydraulic levels by separate activation of fluidizing elements distributed along said conveyor. Specifically, the distribution method is used to supply the receiver units successively starting from the receiver units placed upstream with respect to the conveying direction of the fluidizable material from the tank to the opposite end of the conveyor.

One problem with implementing the distribution method described in the patent application above is that it can be used effectively only on incline conveyors between at least two hydraulic levels and or on conveyors of limited length.

### SUMMARY OF THE INVENTION

The invention relates to a method of distributing a powder via a main conveyor between a feed zone and a plurality of receiver units placed along said main conveyor, said plurality of receiver units comprising at least one downstream receiver unit and at least one upstream receiver unit placed between said feed zone and said downstream receiver unit, said method being characterized in that it comprises:
(a) filling of the main conveyor as far as the downstream receiver unit, or more specifically to the point of the main conveyor to which the downstream receiver unit is connected,
(b) isolating the feed zone after filling the main conveyor, and
(c) conveying the powder from at least one portion of the main conveyor to at least one receiver unit.

The method of the invention is particularly suitable for dispensing alumina to igneous electrolysis cells for producing aluminum. In this application, the alumina is transported and dissolved in the electrolytic bath of an electrolytic cell to be gradually consumed while electrolysis takes place. Alumina must be replaced as and when it is consumed, so that the concentration of dissolved alumina is maintained at an optimal level, conducive to maximum efficiency of the electrolytic cell.

When the method is applied to the distribution of alumina to igneous electrolysis cells for the production of aluminum, the receiver units are usually hoppers placed above the electrolytic cells often called cell feed hoppers.

After step (a), initial filling of the main conveyor as far as the downstream receiver unit, said conveyor is filled with powder at the downstream receiver unit and at the at least one upstream receiver unit, i.e. at each receiver unit placed upstream of said downstream receiver unit. In this way, after initial filling, the downstream receiver unit can be supplied together with any receiver unit placed upstream of said downstream receiver unit.

Advantageously, during the conveying of step (c), all of the powder in the main conveyor is conveyed to all the receiver units.

In the discontinuous distribution methods of prior art, the main conveyor was first filled as far as a first upstream receiver unit, and secondly as far as a second receiver unit placed downstream of said first receiver unit. In cases where the slope of the main conveyor of prior art was slight, the presence of residual powder in the same main conveyor after the first filling as far as the upstream receiver unit could hinder subsequent filling as far as the downstream receiver unit. This risk was even greater because the receiver units to be supplied extended over long distances along the main conveyor.

Without pretending to be bound to any theory, the efficiency of the distribution process according to the invention may be linked to the fact that the initial filling of the main conveyor is done in one go along its entire length as far as the receiver unit furthest downstream or as far as the last receiver unit. In this way, the initial filling of the main conveyor is done in a single “wave” of powder which breaks unhindered and with sufficient energy in the upstream parts of the main conveyor.

The distribution method of the invention can be implemented with a main conveyor which may be either horizontal or inclined, whatever its length.

Preferably, the main conveyor is horizontal. In this way, the heights of the feed hopper and frame are minimized, resulting in a significant reduction in construction costs.

The isolation of the feed zone after filling the main conveyor includes, preferably, the closure of an isolation valve. Alternatively, or preferably in addition, in the case where the main conveyor is fluidized, such isolation can be achieved by disabling a fluidisation element of the main conveyor placed between the feed zone and the receiver unit placed furthest upstream.

The distribution method according to the invention can be implemented with a main conveyor having a length of up to several hundred meters.

When the main conveyor is filled, the feed zone can be isolated before conveying the powder from the main conveyor to any receiver unit. Filling of the main conveyor can be detected using a sensor placed at the end of this conveyor.

According to a preferred embodiment, the main conveyor includes fluidization elements or air corridors, these fluidization elements being respectively associated with portions or sections of said main conveyor to fluidize the powder in each portion of said main conveyor. Each fluidizing element may be designed to fluidize the powder in the portion of the main conveyor with which said fluidizing element is associated, independently of each other.

This embodiment is suitable for transporting fluidizable materials in powder form. The term “fluidizable materials” is intended to include all materials well known to the expert in the field that are in powder form, the grains having a cohesion and a particle size such that the throughput speed of the air blown in through the powder mass leads, at low speed, to decohesion of the particles between each other and a reduction in internal friction forces. Such materials are, for example, alumina to be used for igneous electrolysis, cements, plasters, quick or slaked lime, fly-ash, coal dust, crystals of salts such as calcium fluoride, sodium sulfate, phosphates, etc., plastic aggregates, foodstuffs such as dried milk, flour, etc.

When the powder in the main conveyor is fluidized, it tends to behave like a liquid. Filling (a) of the main conveyor as far as the downstream receiver unit is performed by converting potential energy corresponding to the height of the level of powder in the feeding zone, into kinetic energy of same powder in the main conveyor. It is therefore not necessary for the main conveyor to slope down in order to fill it as far as its end.

When the main conveyor comprises fluidization elements associated with respective portions of said main conveyor, isolation of the feed zone may include disabling of at least one fluidizing element placed between the feed zone and the upstream receiver unit, or more exactly between the feed zone and the point of the main conveyor to which the upstream receiver unit is connected.

According to a preferred embodiment, the receiver units are respectively fed by secondary conveyors.

According to one embodiment, the conveying step (c) is performed simultaneously for all of the powder in the main conveyor to each receiver unit.

According to another embodiment, conveying (c) of the powder from at least part of the main conveyor to at least one receiver unit includes, in any order:
(c1) conveying of powder from a downstream part of the main conveyor to said downstream receiver unit, said downstream part of the main conveyor extending between the upstream receiver unit and the downstream receiver unit, or more precisely between the points of the main conveyor to which the upstream receiver unit and the downstream receiver unit are connected, and
(c2) conveying the powder from an upstream part of the main conveyor to the upstream receiver unit, said upstream part extending to the upstream receiver unit between the feed zone and said upstream receiver unit or more specifically to the point on the main conveyor to which the upstream receiver unit is connected between the feed zone and said point.

In this embodiment, conveying (c2) the powder to the upstream receiver unit can be carried out over the entire upstream part of the main conveyor extending from the feed zone to the upstream receiver unit, or more specifically from the feed zone to the point on the main conveyor to which the upstream receiver unit is connected.

In this embodiment, when the main conveyor includes fluidization elements associated with respective parts of said main conveyor,
filling (a) of the main conveyor as far as the downstream receiver unit may include enabling the fluidization elements placed between the feed zone and the downstream receiver unit, or more precisely between the feed zone and the point on the main conveyor to which the downstream receiver unit is connected,
conveying (c1) of the powder from the downstream part of the main conveyor to said downstream receiver unit may include enabling or maintaining enabled at least one fluidizing element associated with said downstream part, and
conveying (c2) the powder from the upstream part of the main conveyor to the upstream receiver unit may include enabling at least one fluidizing element associated with at least one part of said upstream part of the main conveyor.

In addition, conveying (c1) or conveying (c2) may be followed by disabling the at least one fluidizing element associated with said downstream part, in the case of conveying (c1), or combined with at least one part of said upstream part, in the case of conveying (c2).

In this embodiment, the receiver units are respectively fed by secondary conveyors.
conveying (c1) of the powder from the downstream part of the main conveyor to the downstream receiver unit may additionally include conveying said powder via the secondary conveyor feeding said downstream receiver unit, and
conveying (c2) of the powder from the upstream part of the main conveyor to the upstream receiver unit may additionally include conveying said powder via the secondary conveyor feeding said upstream receiver unit.

According to one embodiment, the method allows the distribution of the powder in a series of N sets of receiver units including
a first set of at least one receiver unit (R1) connected to a first portion of the main conveyor immediately downstream of the feed zone and
a final set of at least one receiver unit (RN) connected to an end portion of said main conveyor placed at an opposite end of said main conveyor with respect to said feed zone,

filling (a) of the main conveyor being carried out as far as said end portion.

Preferably, after filling (a) the main conveyor and for each set of at least one receiver unit (R) connected to the same portion of the main conveyor, each set being considered consecutively, beginning with the last set (RN) up to the first set (R1) or vice versa, said method comprises conveying (ci) of the powder from said portion of said main conveyor to the receiver units (R) of said set under consideration. Advantageously, each set is considered consecutively beginning with the last set (RN) up to the first set (R1).

Preferably, the main conveyor comprises at least one fluidizing element respectively associated with each portion of said main conveyor for fluidizing the powder in said portion of the main conveyor, and in that filling (a) the main conveyor as far as the end portion includes enabling the fluidization elements associated with all portions of said main conveyor. According to a particular embodiment, each element is designed to fluidize the powder in the portion of the main conveyor with which said element is associated, independently of the other portions.

Preferably, for each set of at least one receiver unit (R) connected to the same portion of the main conveyor, conveying (ci) the powder material from said portion of said main conveyor to the receiver units (Ri) of said set under consideration includes enabling or maintaining enabled at least one fluidizing element associated with said portion, said conveying (ci) being followed by the disabling of said at least one fluidizing element associated with said portion.

Preferably, the receiver units are respectively fed by secondary conveyors, and for each set of at least one receiver unit (Ri) connected to the same portion of the main conveyor, conveying (ci) of the powder from said portion of said main conveyor to the receiver units (Ri) of said set under consideration additionally includes conveying via the secondary conveyor feeding the at least one receiver unit (Ri) of said set under consideration.

The invention also relates to a device for dispensing a powder, comprising a main conveyor between a feed zone and a plurality of receiver units placed along said main conveyor, said plurality of receiver units including a downstream receiver unit and at least one upstream receiver unit placed between said feed zone and said downstream receiver unit, said device being characterized in that it comprises means for isolating the feed zone and control means for filling the main conveyor as far as the downstream receiver unit and for conveying the powder from at least one portion of the main conveyor to at least one receiver unit.

Preferably, the main conveyor is substantially horizontal.

Preferably, the dispensing device comprises secondary conveyors for supplying the receiver units.

According to a preferred embodiment, the main conveyor comprises fluidization elements associated with respective portions of said main conveyor for fluidizing the powder in each portion of the main conveyor. The fluidization elements can be designed to fluidize the powder in each portion of the main conveyor independently of each other. In the latter case, each of the main conveyor fluidization elements may include a valve for supplying fluidizing gas to enable or disable fluidization of the powder in the portion of said main conveyor with which said fluidizing element is associated.

According to a preferred embodiment, each secondary conveyor comprises at least one fluidizing element or air corridor to fluidize the powder in said secondary conveyor. In this case, each fluidization element of each secondary conveyor may include a fluidizing gas supply valve to enable or disable fluidization of the powder in said secondary conveyor.

Preferably, the main conveyor includes at least one degassing column.

Preferably, the distribution device comprises at least one sensor for determining the height of the powder in at least one portion of the main conveyor, and in that the control means are connected to said sensor for controlling said device.

The invention also relates to an installation for the production of aluminum comprising a plurality of igneous electrolysis cell feed hoppers fed with alumina from a storage area, said installation comprising a device as described above connected between said storage zone and said cell feed hoppers. In this way, the distribution device can be used to supply several cell feed hoppers connected to different portions or sections of the main conveyor. So each section of the main conveyor makes it possible to feed a plurality of cell feed hoppers for a series of cells located close to said section. Depending on the layout of the installation, it may include several distribution devices, i.e. several main conveyors.

### BRIEF DESCRIPTION OF DRAWINGS

The invention is described in the following with figures illustrating, without limitation, one embodiment of the device and method of the invention.

FIG. 1 is a schematic view of a distribution device suitable for supplying alumina to igneous electrolysis cells for the production of aluminum.

FIG. 2 shows an example of control for the fluidizing gas supply valves of the distribution device in FIG. 1.

FIG. 3 is a schematic view of a distribution device according to another embodiment, also suitable for supplying alumina to igneous electrolysis cells for the production of aluminum.

FIG. 4 shows an example of control for the fluidizing gas supply valves of the distribution device in FIG. 3.

### DETAILED DESCRIPTION

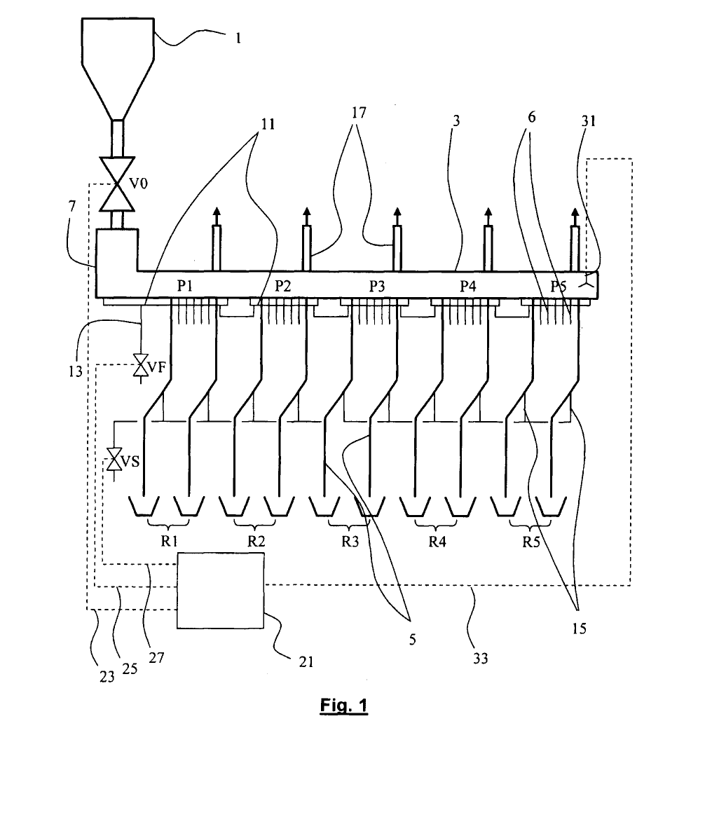

The distribution device shown in FIG. 1 is used to distribute powder between a feed zone of said powder, represented in the form of a storage tank 1, to several sets of receiver units R1, R2, R3, R4, R5 arranged along a main conveyor 3 of the air chute type. The main conveyor is, in turn, subdivided into several portions or sections Pi, and each set Ri of receiver units is connected to a portion Pi of the main conveyor 3. In the embodiment shown, the main conveyor 3 comprises a first portion P1 placed directly downstream of the feed zone, intermediate portions P2, P3, P4, and a final portion P5, placed at an opposite end of said main conveyor relative to said feed zone. The sets of receiver units R1, R2, R3, R4, R5 are connected to portions P1, P2, P3, P4, P5 respectively of the main conveyor 3.

The dispensing device also has secondary conveyors 5 connected between the main conveyor 3 and each of the receiver units. To simplify FIG. 1, only two receiver units have been shown for each set of receiver units R1, R2, R3, R4, R5. The presence of a large number of receiver units for each group has been shown by additional outgoings 6 of secondary conveyors.

The embodiment of the device of the invention shown in FIG. 1 is suitable for supplying alumina to igneous electrolysis cells for producing aluminum. Each section P1, P2, P3, P4, P5 of the main conveyor 3 makes it possible to feed a set of feed hoppers for a series of cells located close to said section, said hoppers thereby corresponding to the receiver units of sets R1, R2, R3, R4, R5.

The storage tank 1 contains the powder in bulk at atmospheric pressure or slightly below atmospheric pressure. The tank makes it possible to keep one end of the main conveyor 3 loaded, via the column of powder in the riser 7 between the feed zone and said main conveyor 3. An isolation valve V0 is used to isolate the storage tank 1 from the main conveyor 3.

The main conveyor 3 comprises fluidization elements 11 associated with portions P1, P2, P3, P4, P5 respectively of said main conveyor to fluidize the powder in each of these portions. The fluidization elements 11 comprise a conduit 13 for supplying fluidizing gas and a supply valve, marked VF, to enable or disable fluidization of the powder throughout the main conveyor 3.

When the fluidization elements 11 of the main conveyor 3 are enabled, the column of powder in the riser 7 endows said powder with potential energy. After opening the isolation valve V0, this potential energy is converted into kinetic energy during filling of the main conveyor 3.

Similarly, the secondary conveyors 5 include fluidization elements, which have not been shown, to fluidize the powder in said secondary conveyors. The fluidisation element for each secondary conveyor 5 also comprises a conduit 15 for supplying fluidizing gas. Each feed conduit 15 is supplied with fluidizing gas by a single supply valve VS to enable or disable fluidization of the powder throughout the secondary conveyors.

The fluidizing elements 11 have not been shown in detail in FIG. 1. These fluidizing elements generally comprise a chamber for supplying fluidizing gas separated from a powder flow conduit by a wall provided with uniformly distributed holes to allow the fluidizing gas into said circulating conduit. These fluidization elements are also called air corridors. Often, the main conveyor 3 and the secondary conveyors 5, are composed of a porous wall separating a lower duct and an upper duct for circulation of the powder as described in French patent application No. 0905372.

The fluidizing gas is generally introduced into the powder flow conduit to facilitate the flow of said powder in said conduit. Fluidizing gas is taken to mean any gas generally used in the fluidization elements 11 to fluidize, under certain conditions, the powder in the flow conduit. The conditions for fluidizing the powder may be based, for example, on the flow of the fluidizing gas, or more specifically, the speed of the fluidizing gas through the holes of the wall separating the fluidizing gas supply chamber from the flow conduit. When this fluidizing gas speed is higher than a minimum fluidization speed, the powder is in a fluidized state. In other words, a suspension of solid powder particles in a gas phase having the flow properties of a liquid is obtained. The primary function of the fluidization elements is to facilitate conveying of the powder in the conveyor, but not necessarily to obtain a fluidized bed as such. This function of the fluidization elements is not, therefore, restricted to obtaining a fluidized bed in the flow conduit of the conveyor or in a portion of the conveyor. Similarly, any reference to the enabling of a fluidizing element implies the establishment of a supply of fluidizing gas into said fluidizing element in conditions that may or may not make it possible to obtain a fluidized bed.

The main conveyor 3 of the distribution device shown in FIG. 1 comprises degassing columns 17 essentially used to remove the fluidizing gas.

The distribution device comprises control means 21 for opening and closing valves V0, VF and VS. The control means 21 are connected to valves V0, VF and VS by control lines 23, 25, 27, 33 shown as dotted lines. These control means 21 make it possible to fill the main conveyor 3 as far as the downstream receiver unit or, more precisely, as far as all the downstream receiver units R5 by controlling opening of the valve V0 and VF, when a high level in said main conveyor is detected by sensor 31. These control means 21 are also used to convey the powder from the whole of the main conveyor belt 3 to each of the receiver units by controlling opening of valve VS. In this way, all the fluidization elements of the main conveyor 11 and of all secondary conveyors 5 are enabled, allowing transfer of the powder to the sets R1, R2, R3, R4, R5 of receiver units.

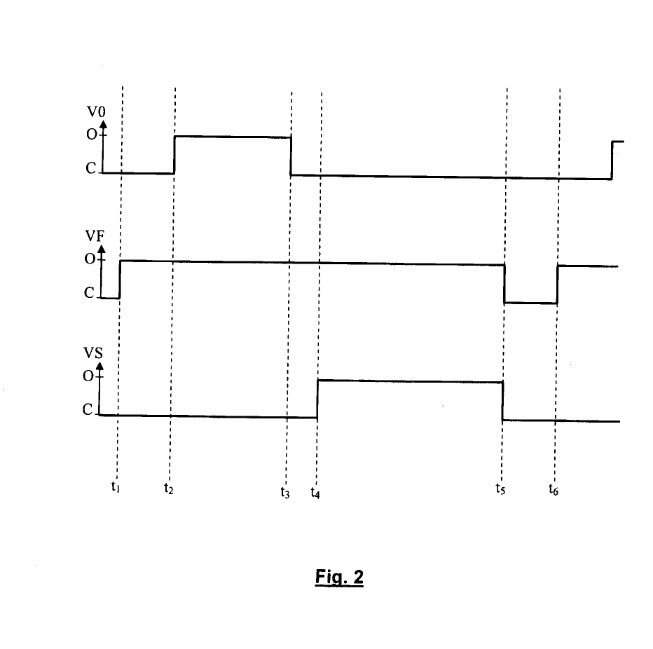

One mode of operation of the distribution device shown in FIG. 1 is described below with the aid of graphs for controlling the isolation valve V0 of the fluidizing gas supply valves VS and VF shown in FIG. 2.

At time t1, valve VF is moved to open position to supply the main conveyor 3 with fluidizing gas over its entire length.

At time t2, isolation valve V0 is moved to open position. Powder may be transferred between the storage tank 1 and the main conveyor 3 via the riser 7. The presence of the fluidization gas in the main conveyor 3 allows powder to flow as far as the end portion P5. The main conveyor 3 is therefore filled in one go and over its entire length. In other words, it is filled by the breaking of a single wave of powder. In this way, the main conveyor 3 is filled with powder in portion P5 at the set R5 of the downstream receiver units and in its portions P1, P2, P3, P4 at sets R1, R2, R3, R4 of receiver units placed upstream. In this way, after the initial filling of the main conveyor 3, it is possible to supply all receiver units distributed along the same main conveyor.

At time t3, the isolation valve V0 is moved to closed position, when a high level is detected by sensor 31. In this way, the supply zone is isolated from the main conveyor 3.

At time t4, the fluidizing gas supply valve VS is moved to open position to convey the powder from the main conveyor belt 3 to each set R1, R2, R3, R4, R5 of receiver units.

At time t5, valves VS and VF are moved to closed position, ready to start another powder distribution sequence.

At time t6, another distribution sequence is initiated and continues in the same way as during the sequence between t1 and t5.

The mode of operation described above is perfectly suitable for transporting alumina between a storage area and a set of igneous electrolysis cell feed hoppers for producing aluminum. The distribution sequence times may be adjusted according to electrolysis operating conditions, and in particular to the consumption rate of the alumina in the electrolytic cells.

In the case of the distribution device in FIG. 1, the control means 21 can be used to adjust the distribution sequence times.

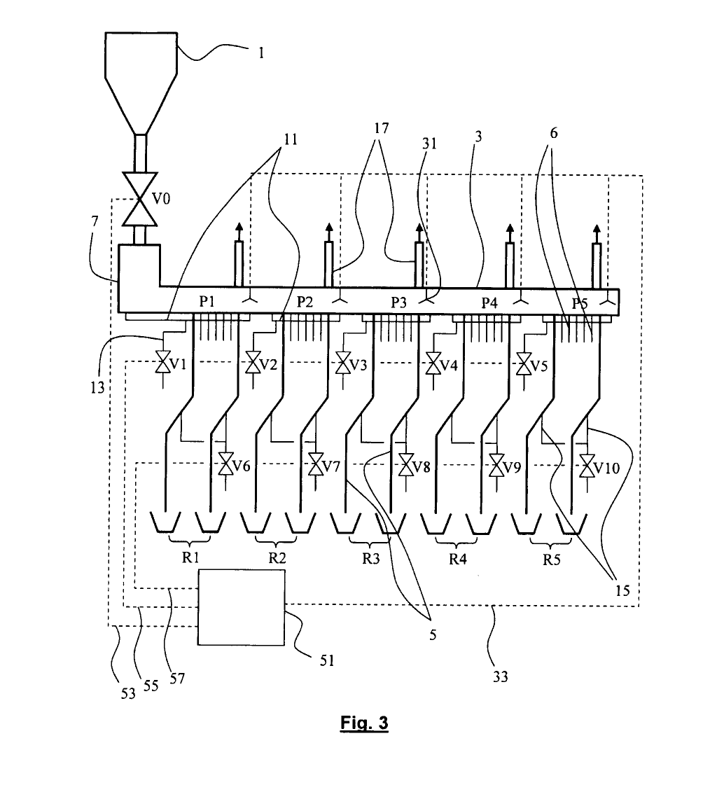

Referring to FIG. 3, the distribution device shown can also distribute powder between a supply zone for said powder, represented as a storage tank 1, to several sets of receiver units R1, R2, R3, R4, R5 arranged along a main conveyor 3. As for the device shown in FIG. 1, the main conveyor 3 is subdivided into several portions Pi, and each set Ri of receiver units is connected to a portion Pi of the main conveyor 3. Relative to the device in FIG. 1, the distribution device in FIG. 3 can, in addition, be used to convey the powder independently between each portion Pi and set Ri of receiver units connected to said portion.

The distribution device shown in FIG. 3 includes many of the elements of the device in FIG. 1. These elements have been shown in FIG. 3 with the same reference numerals as those used in FIG. 1. These elements have already been described with reference to FIG. 1.

As in the embodiment shown in FIG. 1, the main conveyor 3 in FIG. 3 includes fluidizing elements 11 respectively associated with portions P1, P2, P3, P4, P5 of said main conveyor to fluidize the powder in each of these portions. Furthermore, in the embodiment shown in FIG. 3, the fluidization elements 11 can be enabled independently to fluidize the powder in each of these portions, independently of one another. For this, each fluidization element 11 has a supply valve, referenced V1, V2, V3, V4, V5, to enable or disable fluidization of the powder in the portion of the main conveyor 3 with which said fluidization element is associated.

As in the embodiment shown in FIG. 1, the secondary conveyors 5 in FIG. 3 include fluidization elements to fluidize the powder in said secondary conveyors, these fluidization elements being connected by fluidization gas supply conduits 15. In addition, in the embodiment shown in FIG. 3, the fluidization elements of the secondary conveyors 5 of each set R1, R2, R3, R4, R5 of receiver units has a fluidization gas supply valve V6, V7, V8, V9, V10 to enable or disable fluidization of the powder in the secondary conveyors of this same set.

In the embodiment shown in FIG. 3, the distribution device comprises control means 51 to open or close each valve V0 to V10, independently of one another. These control means 51 are connected to valves V0 to V10 by bundles 53, 55, 57 of control lines shown in dotted lines. The control means 51 make it possible to fill the main conveyor 3 as far as the downstream receiver unit or, more precisely, as far as the set of downstream receiver units R5 by controlling the opening of valves V0 to V5. These control means 51 can also be used for conveying the powder from at least one part of the main conveyor to at least one receiver unit. For example, the powder in portion P3 of the main conveyor can be conveyed to receiver units R3 by an opening command to valves V3 and V8. In this way, the fluidization elements 11 of portion P3 of the main conveyor and the secondary conveyors 5 connected between said portion and receiver units R3 are enabled, which facilitates the transfer of the powder from said portion P3 to the set of receiver units R3.

In the embodiment shown in FIG. 3, the distribution device comprises sensors 31 for determining the height of the powder in each portion of the main conveyor 3. The control means 51 are connected to these sensors by a bundle of control lines 33 to control said device.

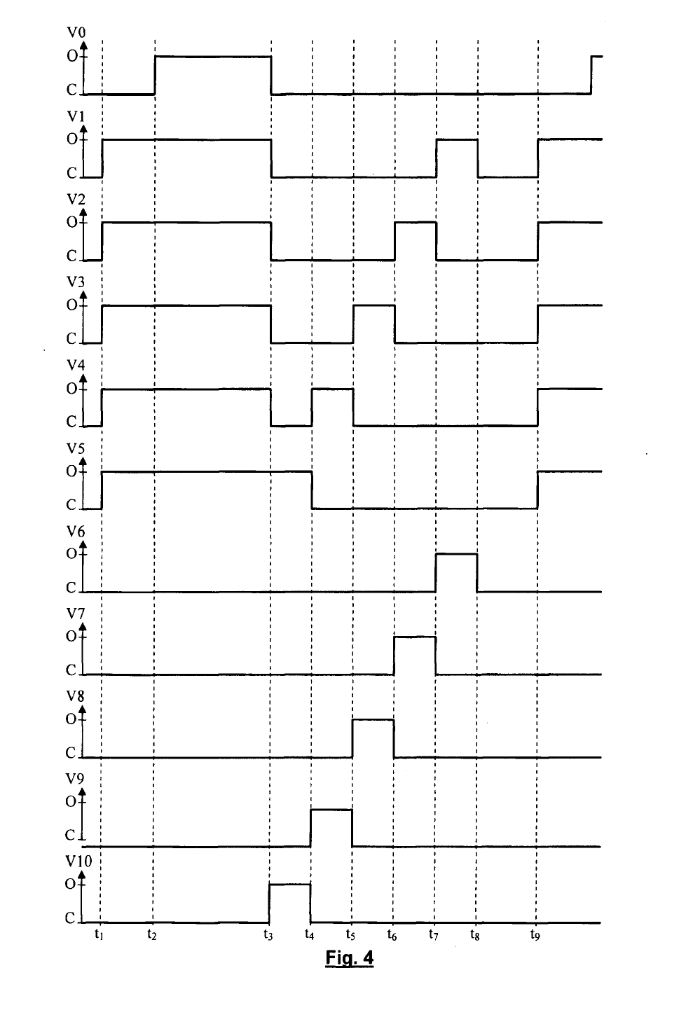

One mode of operation of the distribution device shown in FIG. 3 is described below with the aid of graphs for controlling the isolation valve V0 and the fluidizing gas supply valves V1 to V10 shown in FIG. 4.

At time t1, valves V1 to V5 are moved to open position to supply the main conveyor 3 with fluidizing gas over its entire length.

At time t2, the isolation valve V0 is moved to open position and the powder can be transferred between the storage tank 1 and the main conveyor 3. The main conveyor 3 is filled in the same way as for the device in FIG. 1. Following this initial filling of the main conveyor 3, it is possible to supply all receiver units distributed along the same conveyor.

At time t3, the isolation valve V0 and the valves V1 to V4 are moved to closed position, when a high level is detected by the sensor 31 of portion P5. In this way, the feed zone is isolated from the main conveyor 3 and fluidization in portions P1, P2, P3, P4 of said conveyor is disabled. Maintaining valve V5 in its open position and opening the fluidizing gas supply valve V10 will make it possible to convey the powder from portion P5 of the main conveyor to the set of receiver units R5.

At time t4, after conveying the powder from portion P5 to the set of receiver units R5, a low level is detected by sensor 31 in portion P5. Valves V5 and V10 are then moved to closed position, which disables fluidization in the portion P5 of the main conveyor 3 and in the secondary conveyors connected between said P5 portion and the set of receiver units R5. At the same time, fluidizing gas supply valves V4 and V9 are moved to open position to convey the powder from portion P4 of the main conveyor 3 to the set of receiver units R4.

This process continues in the same way to consecutively convey the powder from each portion of the main conveyor to the sets of receiver units connected to said portion. So at time t5, valves V4 and V9 are closed and valves V3 and V8 are opened to convey the powder from portion P3 to the set of receiver units R3. In the same way at time t6, valves V3 and V8 are closed and valves V2 and V7 are opened to convey the powder from portion P2 to the set of receiver units R2. Still in the same way at time t7, valves V2 and V7 are closed and valves V1 and V6 are opened to convey the powder from portion P1 to the set of receiver units R1.

At time t8, valves V1 and V6 are moved to closed position. Valves V0 to V10 are therefore in closed position ready to start another powder distribution sequence.

At time t9, another distribution sequence is initiated and continues in the same way as during the sequence between t1 and t8.

The mode of operation described above is perfectly suitable for transporting alumina between a storage area and a set of igneous electrolysis cell feed hoppers for producing aluminum. The distribution sequence times may be adjusted according to electrolysis operating conditions, and in particular to the consumption rate of the alumina in the electrolytic cells.

In the case of the distribution device in FIG. 3, the control means 51 are used to adjust the duration of the distribution sequence and control valves V0 to V10 based on measurements of powder levels in each portion of the main conveyor 3.

1. A method for distributing powder by means of a main conveyor between a feed zone and a plurality of receiver units arranged along said main conveyor, said method being characterized in that the method comprises successively:
(a) filling the main conveyor,
(b) isolating the feed zone, and
(c) conveying the powder from at least one portion of the main conveyor to at least one receiver unit.

2. (canceled)

3. Method according to claim 1, characterized in that isolating the feed zone includes closing an isolation valve.

4. Method according to claim 1, characterized in that the main conveyor includes fluidization elements associated with portions of said main conveyor to fluidize the powder in each portion of said main conveyor.

5. (canceled)

6. Method according to claim 1, characterized in that the conveying in step (c) is performed simultaneously for all of the powder in the main conveyor to each receiver unit.

7. Method according to claim 1, characterized in that conveying (c) of the powder from at least one portion of the main conveyor to at least one receiver unit includes, in any order:
(c1) conveying the powder from a downstream part of the main conveyor to at least one downstream receiver unit, said downstream part of the main conveyor extending between at least one upstream receiver unit placed between the feed zone and said downstream receiver unit, and said downstream receiver unit, and
(c2) conveying the powder from an upstream portion of the main conveyor to the upstream receiver unit, said upstream portion extending to the upstream receiver unit between the feed zone and said upstream receiver unit.

8. Method according to claim 1, characterized in that the method allows distribution of the powder in a series of N sets of receiver units comprising:
a first set of at least one receiver unit connected to a first portion of the main conveyor immediately downstream of the feed zone, and
a final set of at least one receiver unit connected to an end portion of said main conveyor placed at an opposite end of said main conveyor with respect to said feed zone,
wherein filling (a) of the main conveyor is carried out as far as said end portion.

9. Method according to claim 8, characterized in that after filling (a) the main conveyor and for each set of at least one receiver unit connected to a same portion of the main conveyor, each set being considered consecutively, beginning with the final set up to the first set or vice versa, said method comprises conveying (c) of the powder from said same portion said main conveyor to the receiver units of said set under consideration.

10. Method according to claim 9, characterized in that the main conveyor comprises at least one fluidizing element associated respectively with each portion of said main conveyor for fluidizing the powder in said portion of the main conveyor, and in that filling (a) the main conveyor as far as the end portion includes activating the fluidization elements associated with all the portions of said main conveyor.

11. Method according to claim 10, characterized in that, for each set of at least one receiver unit connected to the same portion of the main conveyor, conveying (c) the powder material from said same portion of said main conveyor to the receiver units of said set under consideration includes enabling or maintaining enabled at least one fluidizing element associated with said same portion, said conveying (c) being followed by disabling of said at least one fluidizing element associated with said same portion.

12. (canceled)

13. Distribution device for a powder comprising a main fluidized conveyor between a feed zone and a plurality of receiver units placed along said main conveyor, said device being characterized in that the device comprises isolation means of the feed zone and control means for filling the main conveyor, for conveying the powder from at least part of the main conveyor to at least one receiver unit, and to isolate the feed zone between filling the main conveyor and conveying the powder from at least one portion of said conveyor to at least one main receiver unit.

14. Device according to claim 13, characterized in that the main conveyor is substantially horizontal.

15. Device according to claim 13, characterized in that the device includes secondary conveyors for supplying the receiver units.

16. Device according to claim 13, characterized in that the main conveyor includes fluidization elements associated with portions of said main conveyor to fluidize the powder in each portion of the main conveyor.

17. Device according to claim 16, characterized in that the fluidization elements are designed to fluidize the powder in each portion of the main conveyor independently of each other.

18. Device according to claim 17, characterized in that each of the main conveyor fluidization elements may include a valve for supplying fluidizing gas to enable or disable fluidization of the powder in the portion of said main conveyor with which said fluidization element is associated.

19. Device according to claim 15, characterized in that each secondary conveyor comprises at least one fluidization element to fluidize the powder in said secondary conveyor.

20. Device according to claim 19, characterized in that each fluidization element of each secondary conveyor comprises a fluidizing gas feed valve to enable or disable fluidization of the powder in said secondary conveyor.

21. Device according to claim 13, characterized in that the main conveyor comprises at least one degassing column.

22. Device according to claim 13, characterized in that the device comprises at least one sensor for determining a height of the powder in at least one portion of the main conveyor, and in that the control means are connected to said sensor to optimize control of said device.

23. Installation for the production of aluminum comprising a plurality of igneous electrolysis cell feed hoppers supplied with alumina from a storage area, characterized in that said installation comprises a device according to claim 13 connected between said storage area and said cell feed hoppers.
